(19) United States
(12) Patent Application Publication
(10) Pub. No.: US 2008/0093914 A1
(43) Pub. Date: Apr. 24, 2008

(54) Wheel Bearing Device

(76) Inventors: Toru Mabuchi, Tochigi-ken (JP); Satoru Kudo, Tochigi-ken (JP)

Correspondence Address: BIRCH STEWART KOLASCH & BIRCH, PO BOX 747, FALLS CHURCH, VA, 22040-0747, US

(21) Appl. No.: 11/666,816

(22) PCT Filed: Nov. 11, 2005
(86) PCT No.: PCT/JP05/20749

§ 371 Date: May 1, 2007

(30) Foreign Application Priority Data
Nov. 12, 2004 (JP) 2004-328897

(51) Int. Cl. F16D 3/22

(52) U.S. Cl. 301/105.1

(57) ABSTRACT

A wheel bearing device, includes a cylindrical bearing body having a wheel side hub part and a constant velocity joint outer ring part which are formed integrally with each other, a hub bearing having an externally fitted member fitted onto the bearing body and rolling elements, and a nut member fixing the bearing body to the hub bearing supported on a vehicle body side by tightening it to the screw part of the bearing body after the bearing body is press-fitted into the through-hole of the externally fitted member from the wheel side.

### TECHNICAL FIELD

The present invention relates to a wheel bearing device which is capable of supporting a wheel rotatably on a vehicle.

### BACKGROUND ART

Power transmitting systems for transmitting rotational drive power from the engine of an automobile to the drive wheels thereof are required to address angular and axial displacements due to a change in the relative positional relationship between the engine and the wheels. As shown in FIG. 8, for example, there has been employed a structure wherein a drive shaft 1 is interposed between an engine and a drive wheel, and has an end connected to a differential mechanism 3 by a sliding-type first constant velocity universal joint 2 and the other end to a drive wheel 5 by a fixed-type second constant velocity universal joint 4 (see Japanese Laid-Open Patent Publication No. 2000-135903).

The sliding-type first constant velocity universal joint 2 can absorb axial displacements by so-called plunging, and the fixed-type second constant velocity universal joint 4 can only be angularly displaced.

The fixed-type second constant velocity universal joint 4 has an inner joint member 6 mounted on the other end of the drive shaft 1, an outer joint member 8 coupled to a hub member 7, a plurality of torque transmitting balls 9 disposed in ball grooves between the inner joint member 6 and the outer joint member 8, and a retainer 10 interposed between an outer spherical surface of the inner joint member 6 and an inner spherical surface of the outer joint member 8 and retaining the balls 9. The hub member 7 is rotatably supported by a wheel bearing 11, and the drive wheel 5 is fixed to the hub member 7.

The hub member 7, the outer joint member 8 of the second constant velocity universal joint 4, and the wheel bearing 11 are integrally assembled and unitized for use as a drive wheel bearing unit.

Japanese Laid-Open Patent Publication No. 2000-135903 discloses a technical concept for increasing the rigidity of the drive wheel bearing unit for greater durability and making the drive wheel bearing unit smaller and more compact.

Specifically, with the drive wheel bearing unit disclosed by Japanese Laid-Open Patent Publication No. 2000-135903, as shown in FIG. 9, a hub member 12 and an outer joint member 14 of a constant velocity universal joint 13 are provided, wherein at least one of a plurality of inner races of a wheel bearing 15 is formed on the outer joint member 14. The outer joint member 14 has an outer race 14a and a shaft 14b, and the shaft 14b and the hub member 12 are fittingly connected and serration-fitted to each other. The fittingly connected portion is positioned between rolling bodies 16a, 16b that are arranged in double rows.

### DISCLOSURE OF THE INVENTION

However, with the drive wheel bearing unit disclosed by Japanese Laid-Open Patent Publication No. 2000-135903, in order to integrally assemble and unitize the hub member 12, the outer joint member 14 of the constant velocity universal joint 13, and the wheel bearing 15, the inner race for supporting the rolling bodies 16a, 16b for performing a bearing function needs to be machined in an outer circumferential surface of the hub member 12 and an outer circumferential surface of the outer joint member 14 of the constant velocity universal joint 13. Since the race machining step is added to the manufacturing process, the manufacturing cost is high.

Furthermore, the drive wheel bearing unit disclosed by Japanese Laid-Open Patent Publication No. 2000-135903 requires a complex assembling process of assembling the hub member 12, the outer joint member 14 of the constant velocity universal joint 13, and the wheel bearing 15 into a unit and a complex maintenance process for maintaining them.

It is a general object of the present invention to provide a wheel bearing device which allows an assembling process and a maintenance process to be performed simply.

A major object of the present invention is to provide a wheel bearing device which can be manufactured at a reduced cost and hence has its cost reduced.

Another object of the present invention is to provide a wheel bearing device which has a reduced number of parts for a smaller weight.

### BRIEF DESCRIPTION OF THE DRAWINGS

FIG. 1 is a longitudinal cross-sectional view along an axial direction of a wheel bearing device according to an embodiment of the present invention;

FIG. 2 is a longitudinal cross-sectional view, partly omitted from illustration, showing a rotational drive power transmitting mechanism including the wheel bearing device shown in FIG. 1;

FIG. 3 is a longitudinal cross-sectional view illustrative of an assembling process for assembling the wheel bearing device, the view showing the manner in which a bearing body is press-fitted into a hub bearing;

FIG. 4 is a longitudinal cross-sectional view illustrative of the assembling process for assembling the wheel bearing device, the view showing the manner in which a washer and a nut are placed onto the bearing body after the bearing body has been press-fitted into the hub bearing;

FIG. 5 is a longitudinal cross-sectional view illustrative of the assembling process for assembling the wheel bearing device, the view showing the manner in which the nut is tightened to secure the bearing body to the hub bearing;

FIG. 6 is a longitudinal cross-sectional view along an axial direction of a wheel bearing device according to another embodiment of the present invention;

FIG. 7 is a longitudinal cross-sectional view of a wheel bearing device according to still another embodiment of the present invention, shown as being applied to a tripod constant velocity universal joint;

FIG. 8 is a longitudinal cross-sectional view, partly omitted from illustration, showing a conventional rotational drive power transmitting mechanism; and

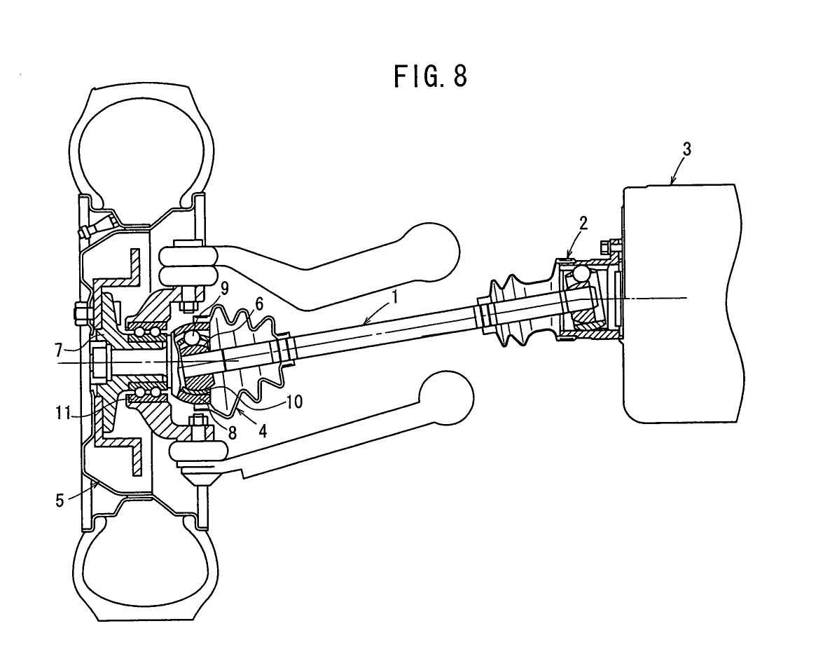

FIG. 9 is a longitudinal cross-sectional view of a conventional drive wheel bearing unit.

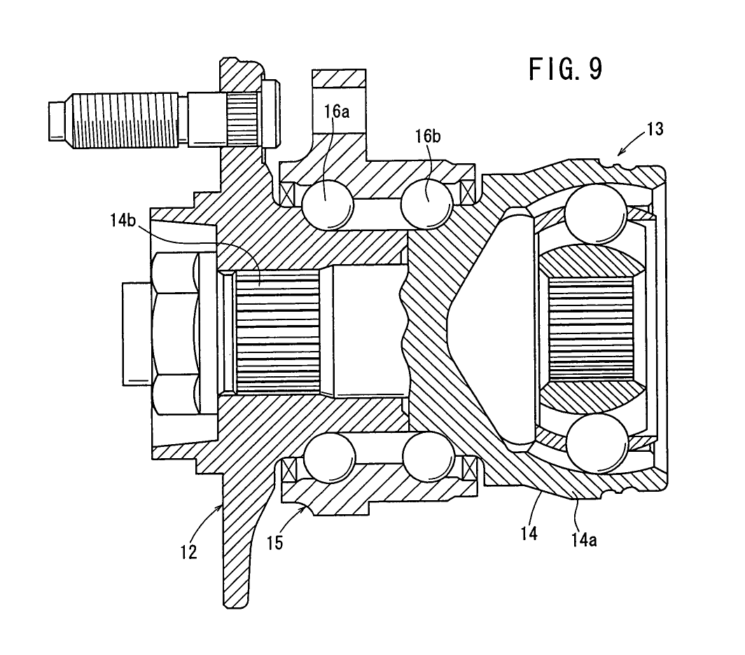

### BEST MODE FOR CARRYING OUT THE INVENTION

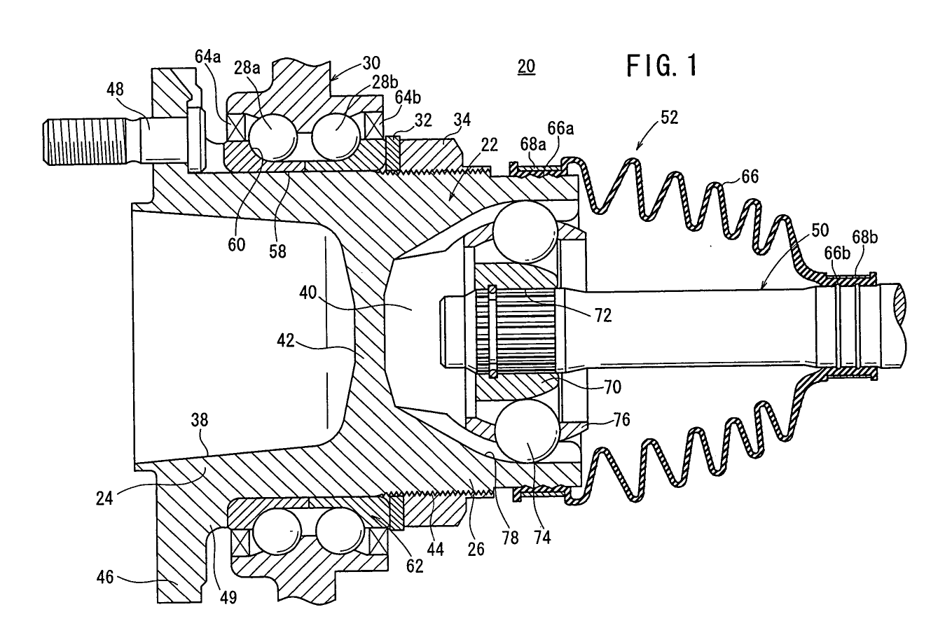

In FIG. 1, the reference character 20 denotes a wheel bearing device according to an embodiment of the present invention.

The wheel bearing device 20 has a bearing body 22 comprising a substantially coaxial integral combination of a hub to which an automobile wheel is to be attached and an outer race member of a constant velocity universal joint. The bearing body 22 comprises a hub portion 24 as the hub and an outer race portion 26 as the outer race member.

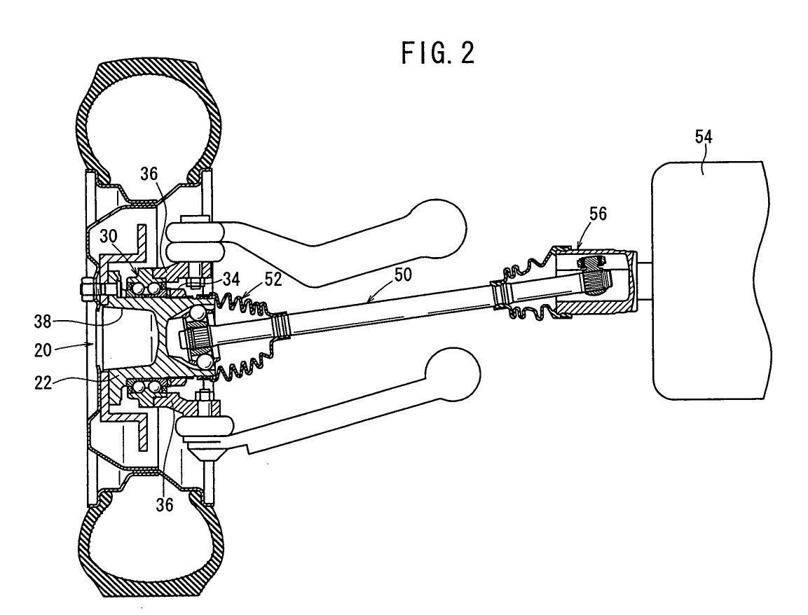

The wheel bearing device 20 also has a hub bearing 30 fitted over an outer circumferential surface of the bearing body 22 and having rolling bodies 28a, 28b comprising a plurality of steel balls rollingly held by a retainer, not shown, a ring-shaped washer 32 and a nut (tightening mechanism) 34 which are fitted over the outer circumferential surface of the bearing body 22 and fixing the bearing body 22 to the hub bearing 30, and a knuckle 36 (see FIG. 2) disposed on an outer circumferential surface of the hub bearing 30.

The bearing body 22 comprises a tubular body having a first recess 38 defined in the hub portion 24 thereof, a second recess 40 defined in the outer race portion 26, and a partition 42 separating the first recess 38 and the second recess 40 from each other. The outer race portion 26 of the bearing body 22 has an externally and partially threaded outer circumferential surface 44 on which the nut 34 is tightened. The nut 34 may have a plurality of loosening-prevention mechanisms, not shown, having a loosening-prevention function, on its outer circumferential surface.

The bearing body 22 may be integrally formed by forging, sizing, or the like. Alternatively, the hub portion 24 and the outer race portion 26 may be manufactured separately from each other, and thereafter may be integrally coupled to each other by friction stir welding, for example.

The hub portion 24 of the bearing body 22 has a wheel mounting flange 46 projecting radially outwardly on an outer circumferential surface thereof. A brake disk and a wheel, not shown, are mounted on the wheel mounting flange 46 by a plurality of hub bolts 48.

The bearing body 22 has a radially outwardly projecting stopper 49 on its outer circumferential surface near the wheel mounting flange 46. After the bearing body 22 is press-fitted into a through hole 58 in an outer fitting member 62, described later, of the hub bearing 30, the outer fitting member 62 is axially displaced as the nut 34 is progressively threaded over the externally threaded surface 44. When the outer fitting member 62 abuts against the stopper 49, the stopper 49 prevents the outer fitting member 62 from being further displaced.

The outer race portion 26 serves as a portion of a Barfield-type constant velocity universal joint 52 that is coupled to an end of a drive shaft 50 to which drive power from an engine or the like is transmitted. Another tripod constant velocity universal joint 56 (see FIG. 2) coupled to a differential mechanism 54 is coupled to the other end of the drive shaft 50.

As described later, the hub bearing 30 has the through hole 58 defined therein. When the hub bearing 30 is to be assembled onto the bearing body 22, the bearing body 22 is press-fitted into the through hole 58 from a wheel side (not shown). The hub bearing 30 also has the outer fitting member 62 having an inner race 60 defined therein with the rolling bodies 28a, 28b being rollingly supported therein, and a pair of seal members 64a, 64b for preventing water, mud, dirt, etc. from entering toward the rolling bodies 28a, 28b from outside of the hub bearing 30. The outer fitting member 62 is made up of a pair of parts.

The knuckle 36 is fixed to a post of a vehicle body suspension device, not shown, by bolts. The hub bearing 30 is fitted in an inner surface of the knuckle 36. Therefore, the hub bearing 30 is secured to the vehicle body, not shown, by the knuckle 36. When the rotational drive power is transmitted through the constant velocity universal joint 52, the outer fitting member 62 disposed radially inwardly of the rolling bodies 28a, 28b, the bearing body 22, the washer 32, and the nut 34 are rotated in unison with each other.

A joint boot 66 in the form of bellows has a larger-diameter end 66a fastened to an outer circumferential surface of the outer race portion 26 by a large-diameter band 68a of metal, and a smaller-diameter end 66b mounted on an outer circumferential surface of the drive shaft 50 by a small-diameter band 68b of metal (see FIG. 1).

An inner ring 70 having a substantially spherical outer circumferential surface is inserted in the outer race portion 26. The inner ring 70 has an axially through hole 72 defined therein substantially centrally by an inner circumferential surface thereof which has spline grooves. The spline grooves in the through hole 72 extend substantially parallel to the axis of the inner ring 70. The end of the drive shaft 50 which is inserted in the through hole 72 has splines disposed on an outer circumferential surface thereof which lies in the through hole 72.

When the end of the drive shaft 50 is inserted into the through hole 72 and the splines are fitted in the spline grooves in the through hole 72, the inner ring 70 and the drive shaft 50 are prevented from rotating relatively to each other, and the drive shaft 50 and the inner ring 70 are allowed to rotate in unison with each other. Therefore, the rotational drive power from the non-illustrated engine or the like is reliably transmitted through the drive shaft 50 to the inner ring 70.

A plurality of balls 74 are disposed between the inner ring 70 and the outer race portion 26 and circumferentially spaced at equal angular intervals. The balls 74 are rotatably housed in retaining windows defined in a retainer 76 and engage in respective track grooves 78 defined in an inner surface of the outer race portion 26. The number of track grooves 78 is the same as the number of balls 74. The track grooves 78 extend along the axial direction of the outer race portion 26.

The wheel bearing device 20 according to the present embodiment is basically constructed as described above. Operation and advantages of the wheel bearing device 20 will be described below.

The rotational drive power produced by the non-illustrated engine or the like is transmitted from the other constant velocity universal joint 56 to the drive shaft 50, rotating the inner ring 70 spline-fitted to the drive shaft 50 in unison therewith. The bearing body 22, which is an integral combination of the outer race portion 26 and the hub portion 24, is rotated by the track grooves 78 engaged by the balls 74 disposed on the outer circumferential surface of the inner ring 70. When the bearing body 22 is rotated, the rotational drive power transmitted from the engine or the like is transmitted to the brake disk and the wheel, not shown, which are mounted on the bearing body 22 by the wheel mounting flange 46 of the bearing body 22.

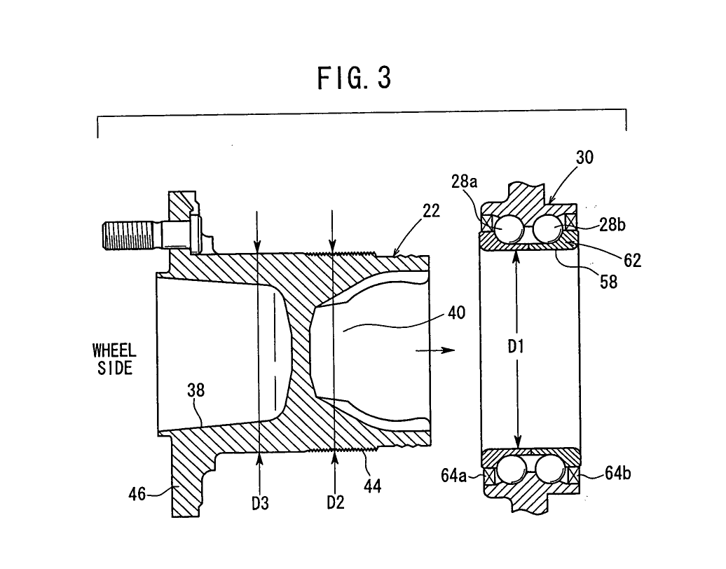

An assembling process of assembling the wheel bearing device 20 according to the present embodiment as an integral unit is shown in FIGS. 3 through 5.

The hub bearing 30, which includes the outer fitting member 62 and the rolling bodies 28a, 28b, is assembled and fixed to the vehicle body, not shown, by the knuckle 36, etc. in advance. With the hub bearing 30 being thus secured to the vehicle body, the bearing body 22, which is an integral combination of the hub portion 24 and the outer race portion 26, is press-fitted into the through hole 58 in the hub bearing 30 from the wheel side, as shown in FIG. 3.

The inside diameter D1 of the outer fitting member 62 of the hub bearing 30 with the through hole 58 defined therein is equal to or greater than the outside diameter D2 of the bearing body 22 including the tooth tips of the externally threaded surface 44, and is slightly greater than the outside diameter D3 of the press-fitted portion near the externally threaded surface 44 (see FIG. 3).

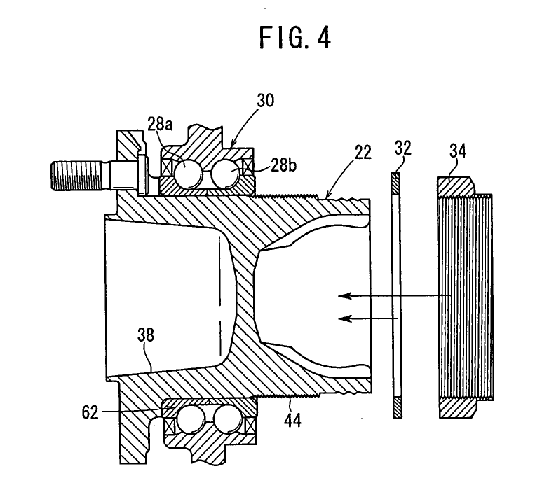

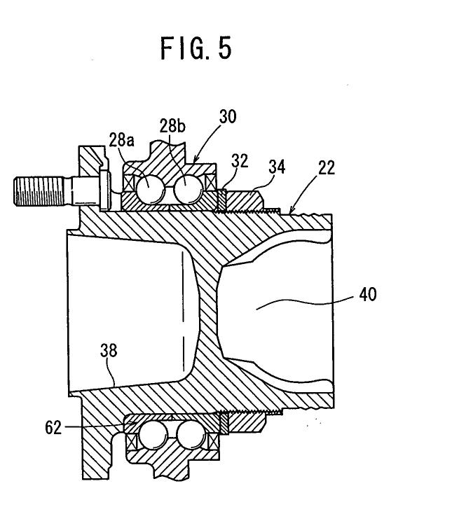

After the bearing body 22 has been press-fitted into the through hole 58 in the hub bearing 30, as shown in FIG. 4, the washer 32 is put onto the bearing body 22 from a side opposite to the wheel side, and the nut 34 is tightened along the externally threaded outer circumferential surface 44 of the bearing body 22. As the nut 34 is progressively tightened along the externally threaded outer circumferential surface 44, the annular stopper 49 projecting from the outer circumferential surface of the bearing body 22 abuts against the outer fitting member 62, whereupon the bearing body 22 is firmly secured to the hub bearing 30 (see FIG. 5).

According to the present embodiment, the bearing body 22 is provided as an integral combination of the hub portion 24 and the outer race portion 26, and the bearing body 22 is press-fitted into the hub bearing 30, thus providing a wheel bearing unit. Therefore, the wheel bearing device is of increased rigidity for greater durability, and is made smaller and more compact.

According to the present embodiment, furthermore, since it is not necessary to machine partially the inner race in an outer circumferential surface of the hub member 12 and an outer circumferential surface of the outer joint member 14 as with the conventional art, the wheel bearing device can be manufactured at a reduced cost and hence has its cost reduced.

According to the present embodiment, furthermore, the bearing body 22 is press-fitted from the wheel side into the through hole 58 in the outer fitting member 62 of the hub bearing 30, and the nut 34 is tightened along the externally threaded surface 44. The simple structure thus provided allows the bearing body 22 to be easily fixed to the hub bearing 30. Consequently, the wheel bearing device allows an assembling process of a unit and a maintenance process to be performed simply.

According to the present embodiment, moreover, even though the bearing body 22 is provided as an integral combination of the hub portion 24 and the outer race portion 26, the hub bearing 30 which has heretofore been used can be utilized as it is. Therefore, the wheel bearing device can be manufactured at a reduced cost.

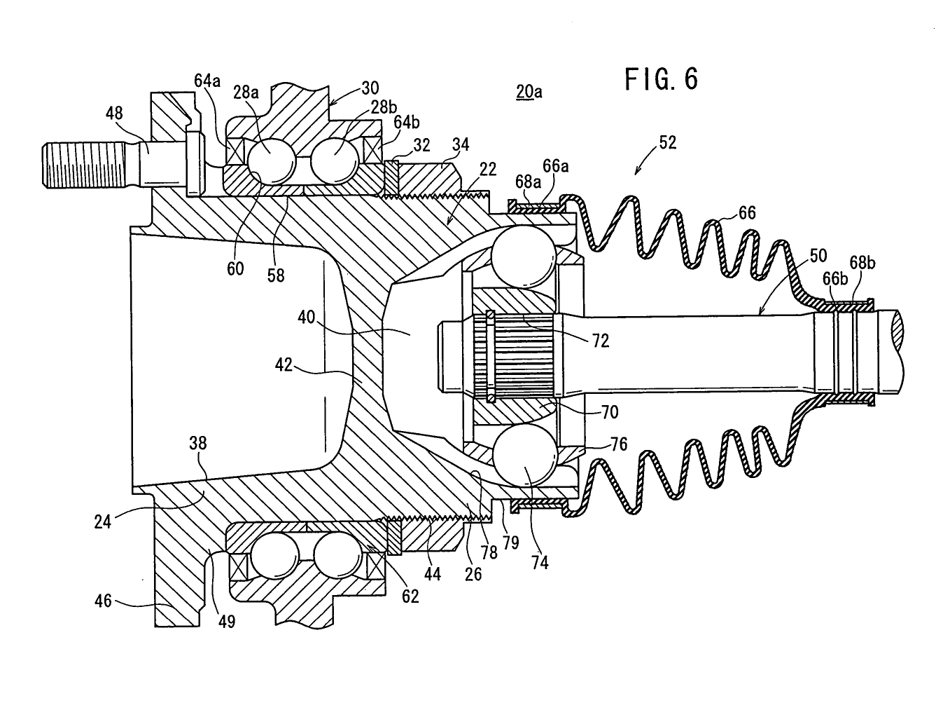

A wheel bearing device 20a according to another embodiment is shown in FIG. 6. Those components of the wheel bearing device 20a which are identical to those of the wheel bearing device 20 according to the above embodiment are denoted by identical reference characters, and will not be described in detail below.

As shown in FIG. 6, the wheel bearing device 20a according to the other embodiment has an annular step 79 on the end of the outer race portion 26 of the bearing body 22, to which the larger-diameter end 66a of the joint boot 66 is fastened by the band 68a, the annular step 79 having a diameter smaller than other parts of the bearing body 22.

The larger-diameter end 66a that is mounted on the annular step 79 has an outer circumferential surface lying substantially flush with the other circumferential surface of the bearing body 22a, and is prevented from projecting radially outwardly. In addition, the wheel bearing device 20a which incorporates the constant velocity universal joint 52 including the drive shaft 50 in the integrally assembled state can easily be mounted or dislodged.

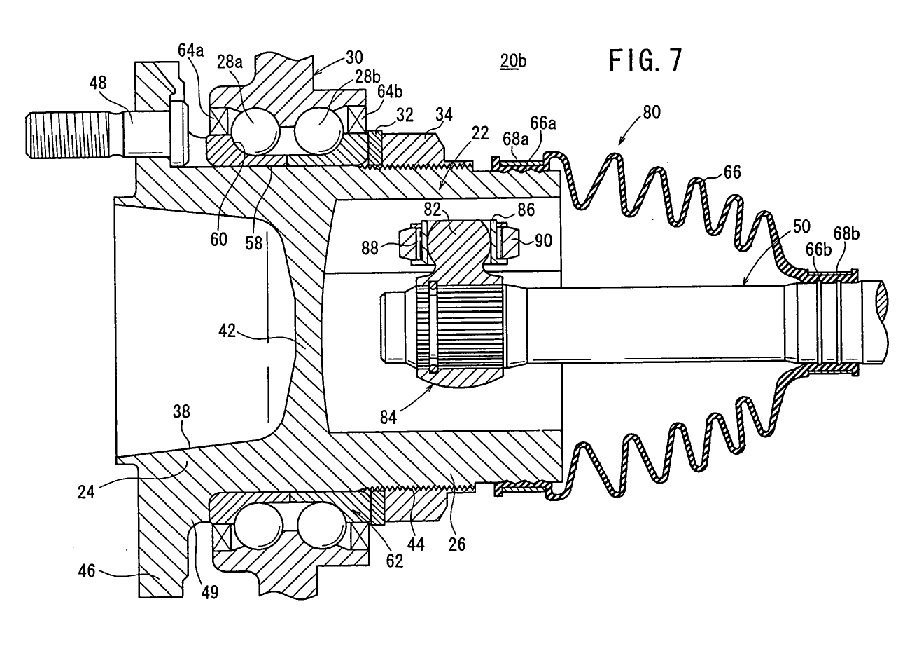

In the embodiments of the present invention, the Barfield-type constant velocity universal joint 52 as shown in FIG. 1 has been described by way of example. However, the present invention is not limited to the Barfield-type constant velocity universal joint 52, but is also applicable to a tripod constant velocity universal joint 80, shown in FIG. 7, which includes a tripod member 84 coupled to the end of the drive shaft 50 and having three trunnions 82, holders 86 engaging the trunnions 82, needle bearings 88, and rollers 90.

1. A wheel bearing device for supporting a wheel rotatably on a vehicle, provided as a unitized assembly of a hub, an outer race member of a constant velocity universal joint, and a hub bearing, comprising:
a tubular bearing body having an integral combination of a hub portion on a wheel side and an outer race portion on a constant velocity universal joint side;
a hub bearing disposed on an outer circumferential surface of said bearing body and having an outer fitting member and rolling bodies; and
a tightening mechanism for fixing said bearing body to said hub bearing by being tightened on said bearing body after said bearing body is press-fitted into a through hole in said outer fitting member from the wheel side.

2. A wheel bearing device according to claim 1, wherein said bearing body is integrally formed by at least forging or sizing.

3. A wheel bearing device according to claim 1, wherein said tightening mechanism comprises a nut tightened along an externally threaded outer circumferential surface of said bearing body.

4. A wheel bearing device according to claim 1, wherein said hub portion of said bearing body has a wheel mounting flange projecting radially outwardly on an outer circumferential surface thereof and a stopper disposed on an outer circumferential portion of said bearing body near said wheel mounting flange for preventing said press-fitted bearing body from being displaced.

5. A wheel bearing device according to claim 1, wherein said outer race portion of said bearing body has an annular step on an end thereof, said annular step having a diameter smaller than other parts of said bearing body.

6. A wheel bearing device according to claim 1, wherein said outer fitting member has an inner race defined in an outer circumferential surface thereof, said rolling bodies being rollingly supported in said inner race.

7. A wheel bearing device according to claim 1, wherein said constant velocity universal joint comprises a Barfield-type constant velocity universal joint having an inner ring and a retainer retaining a plurality of balls.

8. A wheel bearing device according to claim 1, wherein said constant velocity universal joint comprises a tripod constant velocity universal joint having a tripod member having three projecting trunnions.
